(19) United States
(12) Patent Application Publication
(10) Pub. No.: US 2021/0405788 A1
(43) Pub. Date: Dec. 30, 2021

(54) DISPLAY PANEL AND DISPLAY DEVICE

(71) Applicant: Shenzhen China Star Optoelectronics Semiconductor Display Technology Co., Ltd., Shenzhen (CN)

(72) Inventors: Yongfeng LIU, Shenzhen (CN); Liwei KUNG, Shenzhen (CN)

(73) Assignee: Shenzhen China Star Optoelectronics Semiconductor Display Technology Co., Ltd., Shenzhen (CN)

(21) Appl. No.: 16/627,397

(22) PCT Filed: Dec. 17, 2019
(86) PCT No.: PCT/CN2019/126020

§ 371 Date: Dec. 30, 2019

(30) Foreign Application Priority Data
Dec. 10, 2019 (CN) 201911256990.4

(51) Int. Cl. G06F 3/041; G06F 3/044; G02F 1/1343; G02F 1/1333

(52) U.S. Cl. CPC G06F 3/0412; G06F 3/0443; G06F 3/04166; G02F 1/13439; G02F 1/133514; G02F 1/134309; G06F 2203/04103; G06F 2203/04112; G06F 3/0446; G02F 1/13338

(57) ABSTRACT

The present disclosure provides a display panel and a display device. The display panel comprises a substrate and a touch control layer. The touch control layer comprises a transparent electrode layer, a first touch control electrode, a second touch control electrode, and a passivation layer, the passivation layer covers the first touch control electrode and the second touch control electrode, and the first touch control electrode and the second touch control electrode are disposed on a same layer. The present disclosure omits two masking processes, thereby reducing productive cost and improving quality of panels.

### FIELD OF INVENTION

The present disclosure relates to the field of display technologies, and more particularly, to a display panel and a display device.

### BACKGROUND OF INVENTION

Display technologies have rapidly developed. Whether display quality or functions of display screens have achieved breakthrough progresses. Wherein, as an important direction of display technologies, touch control display screens attract attentions for their easy operation and multiple functions.

Current touch control display panels can be divided into resistive touch control display panels, capacitive touch control display panels, and electromagnetic touch control display panels according to induction principles. Since capacitive touch control display panels have advantages of fast response times, high sensitivity, good reliability, and high durability, they have been widely used. However, current display panels are still thick and heavy, and when they are touched, they are often affected by external factors, such as external non-touch operation or screen vibration that affects operations, which cause insensitivity of touch and poor touch control effect. Meanwhile, with the demand for small, portable, and multi-functional display panels, the performance of current touch control display panels can no longer meet the needs of use, and further improvement is needed.

Therefore, it is necessary to provide a solution for the problems in current technology.

Technical problem: in summary, current touch control display panels are susceptible to external interference during touch, thereby causing insensitive touch and poor touch control effect. In addition, touch panels are still thicker, making them inconvenient to carry and use.

### SUMMARY OF INVENTION

To solve the above problems, the present disclosure provides a display panel and a display device to solve the problems of insensitive touch and poor touch control effect of panels and inconvenience for carrying due to a thicker thickness in current touch control display panels.

To solve the above technical problems, an embodiment of the present disclosure provides technical solutions as follows:

In a first aspect, an embodiment of the present disclosure provides a display panel. The display panel comprises:

a substrate; and

a touch control layer disposed on the substrate;

wherein the touch control layer comprises a transparent electrode layer, a first touch control electrode, a second touch control electrode, and a passivation layer, the passivation layer is disposed on the transparent electrode layer and covers the first touch control electrode and the second touch control electrode, and the first touch control electrode and the second touch control electrode are disposed on a same layer;

a material of the transparent electrode layer comprises indium tin oxide, and the first touch control electrode and the second touch control electrode are prepared by a same masking process.

In an embodiment of the present disclosure, wherein the first touch control electrode and the second touch control electrode are disposed in parallel with each other and alternatively arranged.

In an embodiment of the present disclosure, wherein the first touch control electrode and the second touch control electrode are long band-shaped electrodes.

In an embodiment of the present disclosure, wherein at least one row of pixel units of the display panel is disposed between the adjacent first touch control electrode and the second touch control electrode.

In an embodiment of the present disclosure, wherein the first touch control electrode and the second touch control electrode are mesh-shaped metal wirings.

In an embodiment of the present disclosure, wherein the first touch control electrode, the second touch control electrode, and the transparent electrode layer are multiplexed as common electrodes in a touch phase of the display panel to receive a common voltage signal.

In an embodiment of the present disclosure, wherein in the touch phase of the display panel, a potential of the transparent electrode layer resets and is the same as a ground potential.

In an embodiment of the present disclosure, wherein the substrate comprises an array substrate, a color filter substrate disposed opposite to the array substrate, and a liquid crystal layer disposed between the array substrate and the color filter substrate.

In a second aspect, an embodiment of the present disclosure provides a display panel. The display panel comprises:

a substrate; and

a touch control layer disposed on the substrate;

wherein the touch control layer comprises a transparent electrode layer, a first touch control electrode, a second touch control electrode, and a passivation layer, the passivation layer is disposed on the transparent electrode layer and covers the first touch control electrode and the second touch control electrode, and the first touch control electrode and the second touch control electrode are disposed on a same layer.

In an embodiment of the present disclosure, wherein the first touch control electrode and the second touch control electrode are disposed in parallel with each other and alternatively arranged.

In an embodiment of the present disclosure, wherein the first touch control electrode and the second touch control electrode are long band-shaped electrodes.

In an embodiment of the present disclosure, wherein at least one row of pixel units of the display panel is disposed between the adjacent first touch control electrode and the second touch control electrode.

In an embodiment of the present disclosure, wherein the first touch control electrode and the second touch control electrode are mesh-shaped metal wirings.

In an embodiment of the present disclosure, wherein the first touch control electrode and the second touch control electrode are prepared by a same masking process.

In an embodiment of the present disclosure, wherein the first touch control electrode, the second touch control electrode, and the transparent electrode layer are multiplexed as common electrodes in a touch phase of the display panel to receive a common voltage signal.

In an embodiment of the present disclosure, wherein in the touch phase of the display panel, a potential of the transparent electrode layer resets and is the same as a ground potential.

In an embodiment of the present disclosure, wherein the substrate comprises an array substrate, a color filter substrate disposed opposite to the array substrate, and a liquid crystal layer disposed between the array substrate and the color filter substrate.

In a third aspect, an embodiment of the present disclosure further provides a display device. The display device comprises the display panel provided in the embodiments of the present disclosure. The display panel comprises:

a substrate; and

a touch control layer disposed on the substrate;

wherein the touch control layer comprises a transparent electrode layer, a first touch control electrode, a second touch control electrode, and a passivation layer, the passivation layer is disposed on the transparent electrode layer and covers the first touch control electrode and the second touch control electrode, and the first touch control electrode and the second touch control electrode are disposed on a same layer.

In an embodiment of the present disclosure, wherein the first touch control electrode and the second touch control electrode are long band-shaped electrodes.

In an embodiment of the present disclosure, wherein the first touch control electrode and the second touch control electrode are prepared by a same masking process.

Beneficial effect: in summary, the beneficial effect of the embodiments of the present disclosure is:

the present disclosure provides a display panel and a display device by disposing a first touch control electrode, a second touch control electrode, and a transparent electrode layer in a touch control layer of the display panel. The first touch control electrode and the second touch control electrode are disposed on a same film layer. When the display panel is in the display phase, the first touch control electrode, the second touch control electrode, and the transparent electrode layer are multiplexed as common electrodes to receive a common voltage signal; when the display panel is in the touch phase, a potential of the transparent electrode layer resets, and is the same as a ground potential to effectively function as a shielding layer. When manufacturing, this touch control electrode structure omits two masking processes that effectively reduces productive cost of products, thereby improving productive competitiveness.

### DESCRIPTION OF DRAWINGS

FIG. 1 is a schematic structural diagram of each layer of a display panel according to an embodiment of the present disclosure.

FIG. 2 is a schematic diagram of a touch control principle of a display panel according to an embodiment of the present disclosure.

FIG. 3 is a schematic structural diagram of a distribution of first touch control electrodes and second touch control electrodes of a display panel according to an embodiment of the present disclosure.

FIG. 4 is another schematic structural diagram of a distribution of touch control electrodes according to an embodiment of the present disclosure.

FIG. 5 is another schematic structural diagram of a display panel according to an embodiment of the present disclosure.

FIG. 6 is a schematic diagram of a touch control display device according to an embodiment of the present disclosure.

### DETAILED DESCRIPTION OF PREFERRED EMBODIMENTS

The specific embodiments described with reference to the attached drawings are all exemplary and are intended to illustrate and interpret the present disclosure.

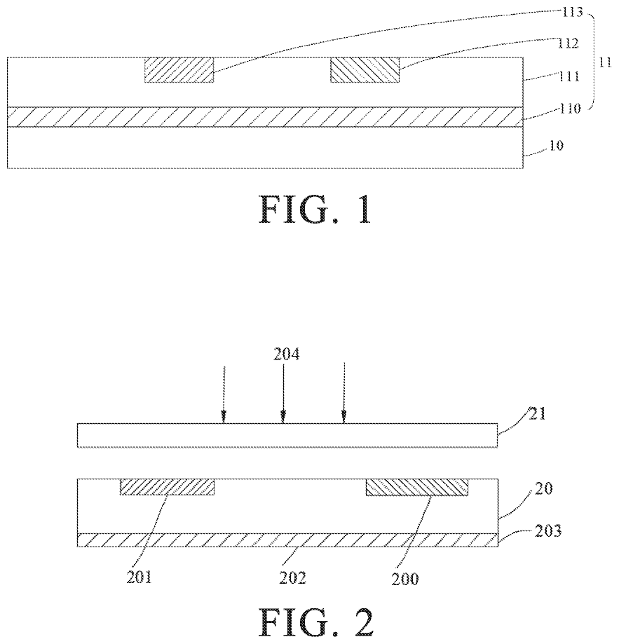

In an embodiment of the present disclosure, as shown in FIG. 1, FIG. 1 is a schematic structural diagram of each layer of a display panel according to an embodiment of the present disclosure. The display panel comprises a substrate 10 and a touch control layer 11. Specifically, the touch control layer 11 is disposed on the substrate 10.

Further, the touch control layer 11 comprises a transparent electrode layer 110, a passivation layer 111, a first touch control electrode 112, and a second touch control electrode 113, the transparent electrode layer 110 is disposed on the substrate 10, the passivation layer 111 is disposed on the transparent electrode layer 110, the first touch control electrode 112 and the second touch control electrode 113 are disposed on the transparent electrode layer 110, and the passivation layer 111 covers the first touch control electrode 112 and the second touch control electrode 113.

In the embodiment of the present disclosure, the first touch control electrode 112 and the second touch control electrode 113 are disposed on a same layer. Only one first touch control electrode 112 and one second touch control electrode 113 are shown in FIG. 1, but actually, the number of first touch control electrodes 112 and second touch control electrodes 113 included in the touch control layer 11 are much greater than the number shown in the figure. The number of the first touch control electrodes 112 and the second touch control electrodes 113 is not specifically limited in the embodiment of the present disclosure. Meanwhile, as an example, the positions and sizes of the first touch control electrode 112 and the second touch control electrode 113 in the figure do not represent positions and sizes in actual production.

As shown in FIG. 2, FIG. 2 is a schematic diagram of a touch control principle of a display panel according to an embodiment of the present disclosure. A substrate 20, a substrate 21, and a transparent electrode layer 203 are provided. The substrate 20 and the substrate 21 are disposed opposite to each other, and the substrate 20 is disposed on the transparent electrode layer 203. Meanwhile, a first touch control electrode 200 and a second touch control electrode 201 are disposed on the substrate 20, and the first touch control electrode 200 and the second touch control electrode 201 are disposed on a same layer.

When an external force 204 is applied to the substrate 21, the substrate 21 transmits the force to the substrate 20. At the same time, the first touch control electrode 200 on the substrate 20 and the transparent electrode layer 203 form a coupling capacitance C1, and the second touch control electrode 201 and the transparent electrode layer 203 form a coupling capacitance C2. The display panel performs calculation, and ensures information of action and positions of touch according to the capacitance C1 and the capacitance C2, thereby achieving touch control operations on the panel.

In the embodiment of the present disclosure, when performing touch control operations on the display panel, the first touch control electrode 200, the second touch control electrode 201, and the transparent electrode layer 203 are multiplexed as common electrodes. That is, in the touch phase of the display panel, a common voltage signal is provided to the first touch control electrode 200, the second touch control electrode 201, and the transparent electrode layer 203, wherein the common voltage signal usually has a constant voltage value.

Meanwhile, in the touch phase of the display panel, a potential of the transparent electrode layer 203 resets, and is the same as the ground potential. That way, since the transparent electrode layer 203 is connected to ground, the transparent electrode layer 203 can function as a shielding layer at the time to effectively shield the touch control layer against influences of film layers under the transparent electrode layer 203, thereby ensuring touch control accuracy and sensitivity when touching. When the display panel is in the display phase, the potential of the transparent electrode layer 203 is the same as a potential on a color filter substrate of the liquid crystal display panel, thereby the transparent electrode layer 203 achieves multiple functions.

The embodiment of the present disclosure disposes the first touch control electrode 200 and the second touch control electrode 201 on a same layer, and makes them have a function as common electrodes, which reduces the whole thickness of the display panel and number of film layers that require vapor deposition, thereby saving productive cost and being beneficial to realize a light and thin design of display panels that meets the needs of users.

Further, to achieve the functions of touch control and displaying of the display panel, the display panel further comprises a bonding area, the bonding area can be connected to a lower substrate of the display panel, and a drive chip is disposed in the bonding area. The drive chip integrates a display control circuit and a touch control circuit. The display control circuit is connected to thin film transistors in the display panel, and the touch control circuit is connected to the first touch control electrode 200 and the second touch control electrode 201. The display control circuit is used to control the thin film transistors to be turned on or turned off that controls transmission and importation of data signals, thereby achieving displaying images of the display panel and having a display function thereof. The touch control circuit is connected to the first touch control electrode 200 and the second touch control electrode 201. When a hand or an external force touches the screen of the display panel, a capacitance between the first touch control electrode 200 and the second touch control electrode 201 corresponding to the touch area will change, and the touch control circuit will calculate the position coordinates of the touch area by detecting capacitance changing area and capacitance values, thereby achieving the touch function of the panel.

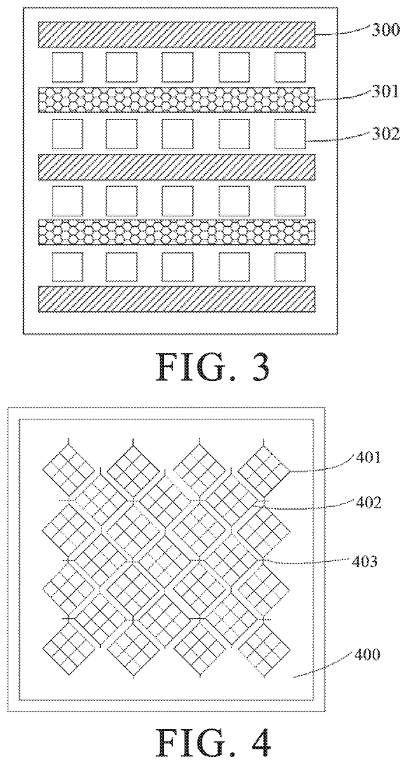

As shown in FIG. 3, FIG. 3 is a schematic structural diagram of a distribution of first touch control electrodes and second touch control electrodes of a display panel according to an embodiment of the present disclosure. The display panel comprises a plurality of first touch control electrodes 300, a plurality of second touch control electrodes 301, and a plurality of pixel units 302. In the embodiment of the present disclosure, the first touch control electrodes 300 and the second touch control electrodes 301 are disposed in parallel with each other and alternatively arranged in a row direction of the display panel. The first touch control electrodes 300 and the second touch control electrodes 301 are long band-shaped electrodes.

In addition, at least one row of pixel units is disposed between adjacent first touch control electrodes 300 and the second touch control electrodes 301. The plurality of pixel units are in an array distribution. The first touch control electrodes 300 and the second touch control electrodes 301 are disposed in a non-open area of pixel units of the display panel to prevent affecting the pixel units to emit light normally. The first touch control electrodes 300 and the second touch control electrodes 301 also can be disposed in a column direction of the display panel and in parallel with each other. In addition, when disposing, the first touch control electrodes 300 and the second touch control electrodes 301 are disposed on a same layer. It should be noted that in the embodiment of the present disclosure, the first touch control electrodes 300 and the second touch control electrodes 301 are arranged alternatively, and according to actual needs, a second touch control electrode 301 may be disposed among a plurality of first touch control electrodes 300. In addition, the number of the first touch control electrodes 300 or the number of the second touch control electrodes 301 is not specifically limited in the embodiment of the present disclosure. In an actual display panel, an actual number of the first touch control electrodes 300 and the second touch control electrodes 301 is much greater than the number of electrodes drawn in the figure.

As shown in FIG. 4, FIG. 4 is another schematic structural diagram of a distribution of touch control electrodes according to an embodiment of the present disclosure. To achieve different touch functions of display panels, a display panel 400 comprises a plurality of first touch control electrodes 400 and second touch control electrodes 401. In addition, when disposing touch control electrodes, the first touch control electrodes 400 and the second touch control electrodes 401 are disposed as mesh-shaped metal electrodes. The plurality of mesh-shaped first touch control electrodes 400 and the plurality of mesh-shaped second touch control electrodes 401 are disposed alternatively in a row direction or in a column direction, and mesh units of each first touch control electrode 400 or each second touch control electrode 401 are connected to each other by electrode bridges 403, thereby disposition of touch control electrodes in the display panel is finished.

The embodiment of the present disclosure disposes the first touch control electrodes 400 and the second touch control electrodes 401 as structures of mesh-shaped metal wirings. On one hand, impedance among the first touch control electrodes 400 and the second touch control electrodes 401 can be effectively reduced, thereby improving touch control sensitivity of touch control electrodes. On the other hand, because the first touch control electrodes 400 and the second touch control electrodes 401 are structures of mesh-shaped metal wirings, ductility of mesh-shaped metal wirings is greater than ductility of stripe or band-shaped wirings, and especially disposing structures of mesh-shaped metal wirings in a flexible display panel can effectively improve performances of the flexible display panel, thereby further improving bending resistance of touch control electrodes of the flexible display panel.

Specifically, the metal electrodes can be made of a metal material with better conductivity, such as gold, silver, copper, zinc, or an alloy containing at least two metals. The above materials have good electrical conductivity, and a resistance of metal materials is much less than a resistance of transparent electrode materials, such as indium tin oxide.

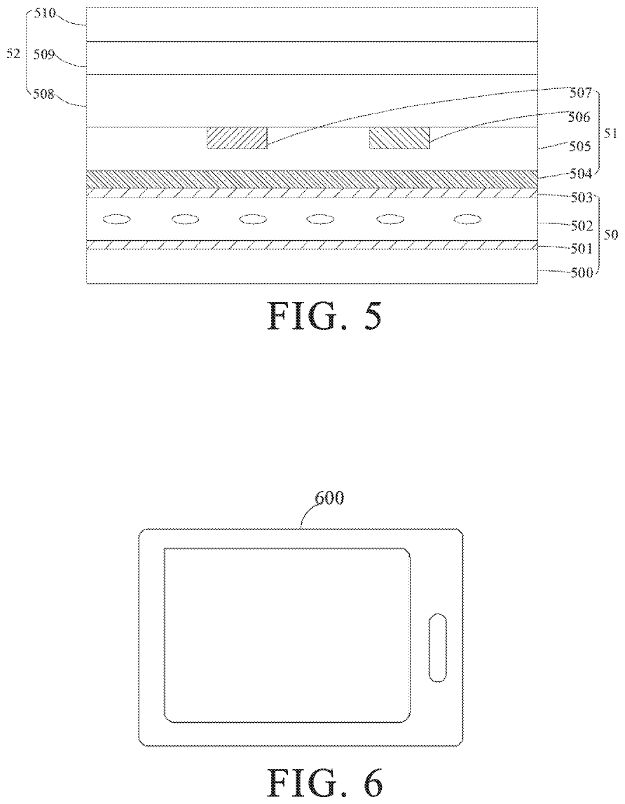

As shown in FIG. 5, FIG. 5 is another schematic structural diagram of a display panel according to an embodiment of the present disclosure. The display panel comprises a substrate 50, a touch control layer 51, and a protective layer 52. The touch control layer 51 is disposed on the substrate 50, and the protective layer 52 is disposed on the touch control layer 51

Specifically, the substrate 50 further comprises a substrate base 500, a thin film transistor array substrate 501, a liquid crystal layer 502, and a color filter substrate 503. The thin film transistor array substrate 501 is disposed on the substrate base 500 and is opposite to the color filter substrate 503. In addition, the liquid crystal layer 502 is disposed between the thin film transistor array substrate 501 and the color filter substrate 503, and is filled with liquid crystals. Wherein, the substrate base 500 may be a glass substrate or a flexible substrate. An electrode pair and a color resist layer may be disposed on the thin film transistor array substrate 501, the electrode pair comprises a pixel electrode and a counter electrode, and a lateral horizontal electric field is generated between the two to control the liquid crystals in the liquid crystal layer 502 to be deflected. The color filter substrate 503 is a transparent substrate, and can be made of glass, polymer plastic materials, such as polyvinyl chloride, or polycarbonate, or other transparent materials. In addition, thin film transistor structures are disposed in the thin film transistor array substrate 501 to ensure the display panel emitting light normally.

The touch control layer 51 also includes a transparent electrode layer 504, a passivation layer 505, a first touch control electrode 506, and a second touch control electrode 507. The transparent electrode layer 504 is disposed on the color filter substrate 503, and the passivation layer 505 is disposed on the transparent electrode layer 504, and covers the first touch control electrode 506 and the second touch control electrode 507. Wherein, the first touch control electrode 506 and the second touch control electrode 507 are disposed on a same layer. When manufacturing, the first touch control electrode 506 and the second touch control electrode 507 can be manufactured by a same mask, thereby simplifying productive processes, reducing productive cost, and improving production efficiency.

The transparent electrode layer 504 can be an indium tin oxide film layer. The transparent electrode layer 504 is disposed on the color filter substrate 503, so it can be an electrode layer of the color filter substrate 503, meanwhile, the transparent electrode layer 504 can also be multiplexed as an electrode layer of the touch control layer 51, and can effectively shield the touch control layer against influences of film layers under the transparent electrode layer 504. The embodiment can effectively reduce the thickness of the display panel, and improve display quality of the panel.

The protective layer 52 also includes a polarizer 508, a protective glass 509, and a cover board 510. The polarizer 508 is disposed on the passivation layer 505, the protective glass 509 is disposed on the film layer of the polarizer 508, and the cover board 510 is disposed on the protective glass 509. To improve display quality of the display panel and have better transmittance, thicknesses of the protective glass 509 and the cover board 510 should not be too thick.

The touch control display panel in the embodiment of the present disclosure can be an in-cell touch panel or an on-cell touch control display panel. Wherein, when disposing the first touch control electrodes and the second touch control electrodes, the first touch control electrodes and the second touch control electrodes are disposed on a same layer, and transparent electrodes are multiplex electrodes, thereby effectively reducing the thickness of the display panel and improving performances of the display panel.

In addition, an embodiment of the present disclosure further provides a touch control display device. As shown in FIG. 6, FIG. 6 is a schematic diagram of a touch control display device according to an embodiment of the present disclosure. A touch control display device 600 comprises the display panel provided in the embodiments of the present disclosure. The first touch control electrodes and the second touch control electrodes are disposed on a same layer. FIG. 6 uses a mobile phone as an example of a touch control display device for description, but the touch control display device is not limited to mobile phones. Specifically, the touch control device may comprise, but is not limited to, any electronic devices with a display function, such as a computer, a tablet computer, and a television.

The display panel and the display device provided by the present disclosure are described in detail above. The description of the above embodiments is only for helping to understand the technical solution of the present disclosure and its core ideas, and it is understood that many changes and modifications to the described embodiment can be carried out without departing from the scope and the spirit of the disclosure that is intended to be limited only by the appended claims.

What is claimed is:

1. A display panel, comprising:
a substrate; and
a touch control layer disposed on the substrate;
wherein the touch control layer comprises a transparent electrode layer, a first touch control electrode, a second touch control electrode, and a passivation layer, the passivation layer is disposed on the transparent electrode layer and covers the first touch control electrode and the second touch control electrode, and the first touch control electrode and the second touch control electrode are disposed on a same layer;
a material of the transparent electrode layer comprises indium tin oxide, and the first touch control electrode and the second touch control electrode are prepared by a same masking process.

2. The display panel according to claim 1, wherein the first touch control electrode and the second touch control electrode are disposed in parallel with each other and alternatively arranged.

3. The display panel according to claim 2, wherein the first touch control electrode and the second touch control electrode are long band-shaped electrodes.

4. The display panel according to claim 2, wherein at least one row of pixel units of the display panel is disposed between the adjacent first touch control electrode and the second touch control electrode.

5. The display panel according to claim 1, wherein the first touch control electrode and the second touch control electrode are mesh-shaped metal wirings.

6. The display panel according to claim 1, wherein the first touch control electrode, the second touch control electrode, and the transparent electrode layer are multiplexed as common electrodes in a touch phase of the display panel to receive a common voltage signal.

7. The display panel according to claim 6, wherein in the touch phase of the display panel, a potential of the transparent electrode layer resets and is the same as a ground potential.

8. The display panel according to claim 1, wherein the substrate comprises an array substrate, a color filter substrate disposed opposite to the array substrate, and a liquid crystal layer disposed between the array substrate and the color filter substrate.

9. A display panel, comprising:
a substrate; and
a touch control layer disposed on the substrate;
wherein the touch control layer comprises a transparent electrode layer, a first touch control electrode, a second touch control electrode, and a passivation layer, the passivation layer is disposed on the transparent electrode layer and covers the first touch control electrode and the second touch control electrode, and the first touch control electrode and the second touch control electrode are disposed on a same layer.

10. The display panel according to claim 9, wherein the first touch control electrode and the second touch control electrode are disposed in parallel with each other and alternatively arranged.

11. The display panel according to claim 10, wherein the first touch control electrode and the second touch control electrode are long band-shaped electrodes.

12. The display panel according to claim 10, wherein at least one row of pixel units of the display panel is disposed between the adjacent first touch control electrode and the second touch control electrode.

13. The display panel according to claim 9, wherein the first touch control electrode and the second touch control electrode are mesh-shaped metal wirings.

14. The display panel according to claim 9, wherein the first touch control electrode and the second touch control electrode are prepared by a same masking process.

15. The display panel according to claim 9, wherein the first touch control electrode, the second touch control electrode, and the transparent electrode layer are multiplexed as common electrodes in a touch phase of the display panel to receive a common voltage signal.

16. The display panel according to claim 15, wherein in the touch phase of the display panel, a potential of the transparent electrode layer resets and is the same as a ground potential.

17. The display panel according to claim 9, wherein the substrate comprises an array substrate, a color filter substrate disposed opposite to the array substrate, and a liquid crystal layer disposed between the array substrate and the color filter substrate.

18. A display device, comprising a display panel, wherein the display panel comprises:
a substrate; and
a touch control layer disposed on the substrate;
wherein the touch control layer comprises a transparent electrode layer, a first touch control electrode, a second touch control electrode, and a passivation layer, the passivation layer is disposed on the transparent electrode layer and covers the first touch control electrode and the second touch control electrode, and the first touch control electrode and the second touch control electrode are disposed on a same layer.

19. The display device according to claim 18, wherein the first touch control electrode and the second touch control electrode are long band-shaped electrodes.

20. The display device according to claim 18, wherein the first touch control electrode and the second touch control electrode are prepared by a same masking process.
